(19) United States
(12) Patent Application Publication
(10) Pub. No.: US 2012/0045496 A1
(43) Pub. Date: Feb. 23, 2012

(54) IONIZED PERFORMANCE FABRIC WITH ANTIMICROBIAL/ANTIBACTERIAL/ANTIFUNGAL PROPERTIES

(76) Inventors: Dan C. Short, Paris, KY (US); Bryan S. Short, Lexington, KY (US); Albert B. Quimet, Lexington, KY (US)

(21) Appl. No.: 13/201,357

(22) PCT Filed: Feb. 12, 2009
(86) PCT No.: PCT/US09/33910

§ 371 Date: Nov. 4, 2011

(51) Int. Cl. A01N 25/34; A01N 41/10; A01N 43/40; B05D 3/00; A01P 1/00; A01P 3/00; B05D 7/00; A01N 31/16; A01N 59/16

(52) U.S. Cl. 424/404; 514/735; 514/709; 514/348; 424/618; 427/372.2

(57) ABSTRACT

A composition for treating fabric includes about 0.1 to about 10.0% cross linking agent, about 0.1 to about 5.0% of a material selected from a group consisting of oxidized polyolefin, polyolefin and mixtures thereof, about 0.1 to about 0.5% wetting agent, about 1.0 to about 14.0% of a material selected from a group consisting of aminofunctional silicone, ionizing agent and mixtures thereof, about 0.0 to about 2.0% catalyst, about 1.0 to about 3.0% antimicrobial/antibacterial/antifungal agent and any remainder as a carrier. The composition has a pH of between about 2.0 to about 4.0. A performance fabric treated with the composition and a method of treating a performance fabric are also provided.

### TECHNICAL FIELD AND INDUSTRIAL APPLICABILITY OF THE INVENTION

The present invention relates generally to the clothing field, and more particularly, to specialty garments, surgical masks, bandages and tapes and compositions for treating those fabrics and products. The compositions are also useful in treating, medical wraps and domestic fabrics such as sheeting, pillowcases, bed coverings and throws. The compositions are furthermore useful in imparting antimicrobial/antibacterial/antifungal properties to textile fabrics and garments but also to polymers such as polyvinylchloride, nitrile rubber and polyacrylates for use in food packaging, surgical gloves, examining gloves and food service gloves.

### BACKGROUND OF THE INVENTION

The present invention relates to specialty fabrics and clothes such as shirts, pants, socks, underwear, sweaters, coats, gloves, mittens, shoes, hats and other head wear. The invention also relates to surgical masks, bandages and tapes as used in the medical field. Individuals wearing clothing, bandages, wraps and/or tapes constructed from the specialty fabric of the present invention against their skin have observed substantial increases in oxygen levels in the bloodstream, circulation and muscle recovery, static and dynamic endurance, performance, speed, quickness and reaction time. Further, wearers of the specialty fabric have also experienced energized endorphins, increases in immunologic A, an important immune factor, and enhanced anti-inflammatory effectiveness. Wearing the clothes, bandages, wraps and/or tapes of the present invention enables an athlete to perform better, perform longer and have greater muscle elasticity, less warm up time and faster recovery. A person sleeping on mattress covers, sheets and pillowcases containing this treatment will enjoy a deeper, more relaxing sleep and awake feeling more rested. Incorporating an antimicrobial/antibacterial/antifungal agent into this composition will allow the wearer not only to feel fresher but the item of clothing such as shirts, pants, socks, underwear and undergarments, sweaters coats, gloves, mittens, shoes, hats and other head wear, along with surgical masks, bandages and tapes along with surgical gloves, examination gloves, food service gloves and food packaging will inhibit the growth of gram positive and gram negative bacteria and aspergillus niger (black mold) and any other harmful mold or fungus.

Further, when worn in a surgical operating suite, treated gloves will provide the surgical team with antimicrobial/antibacterial/antifungal properties. Not only will the surgical team realize these properties and their protection from gram positive and gram negative bacteria and black mold, the patient will also receive these benefits because the gloves will be inherently treated at point of manufacture.

Food packaging films, treated with this composition will extend shelf life of food and protect against the effects of salmonella and E. coli bacteria.

Food service personnel, wearing gloves treated with this composition will be protected; and furthermore, because the gloves are inherently treated, no harmful bacteria will be transferred to other surfaces with which these gloves conic in contact. Because this composition consists of a combination of ionized technology and antimicrobial/antibacterial/antifungal agents, the wearer will experience the benefits of ionized substrates. Individuals wearing these treated gloves will feel more energized and will be subjected to less muscle cramping in the hands because of lactic acid management in the muscle tissue.

### SUMMARY OF THE INVENTION

In accordance with the purposes of the present invention as described herein, a composition is provided for treating fabric or polymeric films such as nitrile rubber, polyvinylchloride, ethylvinylacetate, polyacrylate or combinations thereof. The composition comprises in weight percent about 0.1 to about 10.0% cross linking agent, about 0.1 to about 5.0% of a material selected from a group consisting of oxidized polyolefin, polyolefin and mixtures thereof, about 0.1 to about 0.5% wetting agent, about 1.0 to about 14.0% amino functional silicone, ionizing agent and mixtures thereof, about 0.0 to about 2.0% catalyst, about 1.0 to about 3.0% antimicrobial/antibacterial/antifungal agent and any remainder as a carrier. The composition has a pH of between 2.0 to about 4. This is necessary to provide the desired properties to the fabric such as ionization and antimicrobial/antibacterial/antifungal activity.

More specifically describing the invention, the cross linking agent is selected from a group consisting of a polycarboxylic acid, a low molecular weight polymaleic acid, a copolymer of malefic acid and other monomers, citric acid, butanetetracarboxylic acid and mixtures thereof and the polyolefin is selected from a group consisting of polyethylene, polypropylene and mixtures thereof

The amino functional silicone is ionizeable and is selected from a group consisting of silicone polymers containing amine groups and mixtures thereof. The catalyst is selected from a group consisting of sodium hypophosphite, sodium phosphate, sodium hydroxide, sodium carbonate and mixtures thereof. The ionizing agent is selected from a group consisting of choline chloride, chitosin, glycidyl-trimethylammonium chloride other reactive quaternary ammonium compounds and mixtures thereof. The wetting agent is selected from a group consisting of nonionic and anionic surfactants and mixtures thereof.

The antimicrobial/antibacterial/antifungal agent is selected from a group consisting of an aqueous dispersion based upon 5-chloro-2-(2,4 dichlorophenoxy)phenol, a water based suspension of diiodomethyl-p-tolyl sulfone, a finely divided powder of diiodomethyl-p-tolyl sulfone, a finely divided suspension of imidazole and pyrithione, a water based solution based upon silver ion technology and mixtures thereof. The carrier is selected from a group consisting of water, air, alcohol, other water soluble compounds and mixtures thereof with or without water.

In accordance with additional aspects of the present invention, a performance fabric is provided that has been treated with the composition of the present invention. An associated method of preparing a performance fabric is also provided.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIGS. 1-3 are cross-sectional views illustrating three possible embodiments of the specialty fabric of the present invention.

FIG. 4 is a perspective view of a surgical mask made in accordance with the teachings of the present invention; and

FIG. 5 is a side elevational view of medical tape, made in accordance with the teachings of the present invention.

Reference will now be made in detail to the present preferred embodiments of the invention, examples of which are illustrated in the accompanying drawings.

### DETAILED DESCRIPTION OF THE PREFERRED EMBODIMENTS OF THE INVENTION

In accordance with the present invention an ionized finish is durably fixed to a textile fabric by treating the fabric in an appropriate composition. The particular chemistry utilized to impart ionized groups to the fabric depends upon the particular textile fiber and the balance of physical and chemical properties expected from the finished fabric. The goal is provide an ionized finish that will function to enhance the physiologic and athletic performance of the wearer or to provide a more relaxing night's sleep.

One composition useful in the present invention comprises in weight percent about 0.1 to about 10.0% cross linking agent, about 0.1 to about 5.0% of a material selected from a group consisting of oxidized polyolefin, polyolefin and mixtures thereof, about 0.1 to about 0.5% wetting agent, about 1.0 to about 14.0% aminofunctional silicone, ionizing agent and mixtures thereof, 0.0 to about 2.0% catalyst, about 1.0 to about 3.0% antimicrobial/antibacterial/antifungal agent and any remainder as a carrier wherein the composition has a pH of between about 2.0 to about 4.0.

More typically the composition includes about 1.0 to about 4.0% cross linking agent, about 0 to about 3.0% oxidized polyolefin, polyolefin or mixtures thereof, about 0.1 to about 0.5% wetting agent, about 1.0 to about 6.0% ionizing agent, about 0.5 to about 2.0% catalyst, about 0.2 to about 4.0% aminofunctional silicone, about 1.0 to about 3.0% antimicrobial/antibacterial/antifungal agent and a carrier with the composition having a pH of between about 2.6 and about 4.0. The polyolefin is typically polyethylene and/or polypropylene. The aminofunctional silicone functions as a softener while also providing an ionization effect and is typically used in the composition when treating cotton and cotton blend fabrics. It does not have to be but could be included in the composition when treating synthetics.

The cross linking agent may be substantially any appropriate material useful for the intended purpose of binding the ionizing agent to the fabric being treated. Cross linking agents include but are not limited to polycarboxylic acids, low molecular weight polymaleic acid, a copolymer of maleic acid and other monomers, citric acid, butanetetracarboxylic acid and mixtures thereof. Other effective cross linking agents include polyfunctional blocked isocyanates and polyfunctional epoxides.

The cross linking agent may be substantially any appropriate material useful for the intended purpose of binding the ionizing agent to the fabric being treated. Cross linking agents include but are not limited to polycarboxylic acid, low molecular weight polymaleic acid, a copolymer of maleic acid and other monomers, citric acid, butanetetracarboxylic acid and mixtures thereof. Other effective cross linking agents include polyfunctional blocked isocyanates and polyfunctional epoxides.

The aminofunctional silicones must be an ionizeable silicone and may, for example, be selected from a group consisting of various silicone polymers containing amine groups. The amine groups may be primary, secondary, tertiary, or quaternary and mixtures thereof. Catalysts appropriate for use in the composition of the present invention include sodium hypophosphite, sodium phosphate, sodium hydroxide, sodium carbonate and mixtures thereof. Ionizing or finishing agents appropriate for use in the composition include but are not limited to choline chloride or other reactive quaternary compounds (e.g. glycidyl-trimethylammonium chloride, chitosan (under slightly acid conditions) and those described in publications: Textile Chemist and Colorist, October 1989, p. 23 by David M. Lewis and Xiaoping Lei; Journal of Coated Fabrics, Vol. 18, April 1989, p. 234 by R. J. Harper, Jr.; Journal of Coated Fabrics, Vol. 17, January 1988, p. 197 by R. J. Harper, Jr. and A. H. Lambert) and mixtures thereof. Wetting agents useful in the present invention include but are not limited to nonionic and anionic surfactants and mixtures thereof.

The antimicrobial/antibacterial/antifungal agent is typically selected from a group of agents consisting of an aqueous dispersion based upon 5-chloro-2-(2,4 dichlorophenoxy)phenol, a water based suspension of diiodomethyl-p-tolyl sulfone, a finely divided powder of diiodomethyl-p-tolyl sulfone, a finely divided suspension of imidazole and pyrithione, a water based solution based upon silver ion technology and mixtures thereof. Usually the carrier is water. However, other carriers such as air, alcohols, and other water soluble compounds and mixtures thereof with or without water may be utilized.

This composition is particularly useful in treating wool, silk, regenerated cellulose and noncellulosic, synthetic fibers such as polyester, nylon, elastomerics, acrylics, and mixtures thereof whether blended with cellulosic fibers or not.

The composition is applied to the fabric by blotting, spraying, soaking, foaming or any other appropriate means. The composition is then dried and cured. The percent wet pickup may vary from 10 to 120 percent depending on the fabric and the level of treatment desired. After drying, the cure temperature will depend on the time permitted for curing. Conditions may vary from, for example, 10 seconds at 380° F. to 20 minutes at 280° F. It is the cross linking agent that is effective in fixing the cationic compound such as choline chloride to the fabric. This reaction in combination with oxidized polyolefins, such as polyethylene and polypropylene, and aminofunctional silicones have been effective in achieving desirable ionic properties on the wool or synthetic fibers.

Three possible embodiments of the performance fabric of the present invention are illustrated in FIGS. 1-3. Of course, it should be realized that these different embodiments are simply presented for purposes of illustration and that the invention should not be considered as limited thereto.

In the first embodiment illustrated in FIG. 1, the fabric 10 comprises a single layer of a substrate 12 treated with one of the compositions previously described. The fabric substrate may be a cellulosic material, a noncellulosic synthetic material or a blend of the two. Fabric substrates treated with the composition of the present invention include but are not limited to cotton, linen, rayon, polyester, nylon, elastomers, acrylics, wool, silk, and blends and mixtures thereof.

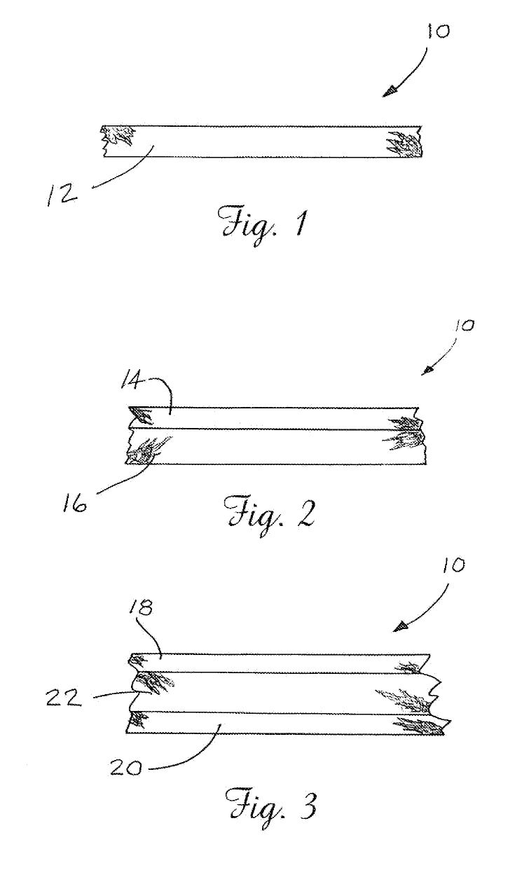

An alternative embodiment of the performance fabric 10 of the present invention is illustrated in FIG. 2. In this embodiment the fabric 10 comprises a substrate layer 14 treated with the previously described composition in order to provide ionized properties and a second layer 16 of a filter material. That filter material may, for example, comprise a fabric treated with a known filtering material such as charcoal, activated carbon, chlorophyll, baking soda, activated alumina, soda lime, zeolite, calcium oxide, potassium permanganate or the like. In one possible embodiment that layer 16 comprises a fabric substrate encapsulated with activated carbon using a polyfilm. Such a filtering layer 16 reduces the release of body odor to the environment, allows for moisture management, while also protecting the covered skin from noxious chemicals in the environment. Thus, it serves a number of functions.

A third embodiment of the performance fabric 10 of the present invention is illustrated in FIG. 3. In this embodiment the performance fabric 10 comprises three separate layers. The outer two layers 18, 20 are constructed from a cellulosic material such as cotton, rayon, linen and any mixtures thereof or a noncellulosic synthetic material such as nylon, polyester, elastomers, acrylics, and mixtures thereof or even a blend of the two types of materials/fibers or natural fibers such as silk, wool, ramie, jute or blends thereof. Either or both of the layers 18, 20 may be treated with the performance enhancing compositions of the present invention in order to provide an ionization effect. A third layer 22 of filtering material may be provided between the first two layers 18, 20. The third layer 22 may comprise a fabric substrate treated with a filtering agent in the manner described above like the layer 16.

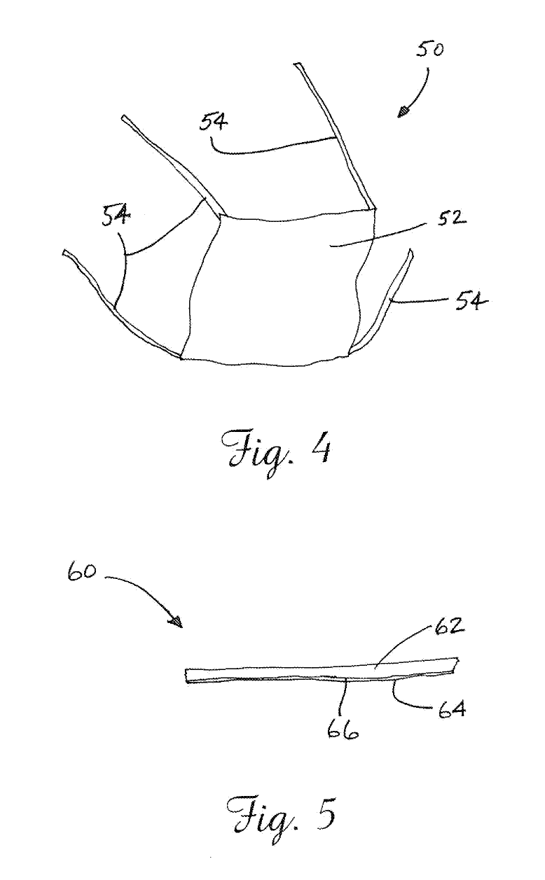

A medical mask 50 is illustrated in FIG. 4. The medical mask 50 includes a body 52 and tie straps 54. At least the body 52 of the mask 50 is constructed from the ionized fabric of the present invention illustrated in any of FIGS. 1-3.

A medical tape 60 is illustrated in FIG. 5. The medical tape 60 includes a strip of fabric 62 having an adhesive 64 on one face 66 thereof. The strip of fabric 62 is constructed from the ionized fabric of the present invention as illustrated in any of FIGS. 1-3.

Substantially any type of clothing, medical wraps, surgical masks, bandages, medical tapes and domestic fabrics such as sheeting, pillowcases, bed covering, and throws may be constructed from the performance fabrics of the present invention illustrated in FIGS. 1-3. For example, the fabrics may be utilized to construct shoes, socks, pants, shorts, underwear and undergarments, shirts, sweaters, scarves, gloves, mittens and any type of hat or other head wear. All of the performance fabrics illustrated in FIGS. 1-3 include an ionized characteristic that provides various beneficial physiological effects to a wearer of clothing constructed from the fabrics. In addition the FIGS. 2 and 3 embodiments incorporate an additional filtering layer 16, 22 that functions to both reduce body odor, provide comfort through moisture management, and protect the pores of skin covered by the fabric from noxious gaseous materials in the environment. Thus, unique, multiple benefits are achieved by the wearer heretofore unknown in the art.

The fibers of the fabric substrates utilized to make the clothing may be imparted with ionized properties by a number of methods. The chemistry will depend on both the fibers and the particular chemical group to be fixed. As would be expected, cellulosic fibers respond differently from non-cellulosic synthetics. Furthermore the finish will also depend on the final balance of physical properties desired for the garment.

For cellulosic fibers such as cotton, rayon, and linen, ionic groups may be fixed by a number of methods. Some of these approaches include (1) partial carboxymethylation using a sodium salt of chloroacetic acid and sodium hydroxide; (2) reactive polycarboxylic acids with appropriate catalyst, pH and heat; (3) phosphorylation with ammonium phosphate and urea; (4) sulfation with appropriate salts of sulfamic acid; (5) fixation of reactive dyes and colorless reactive dyes; (6) fixation of epoxy functional cationic compounds; and (7) fixation of ionic polymers such as carboxymethyl cellulose, sulfonated phenolic/formaldehyde polymers, carboxylated acrylic polymers, partial oxidized polyethylene and aminofunctional silicones.

Non-cellulosic synthetic fiber such as polyester and nylon are not as reactive as the cellulosic fibers. For these non-cellulosic synthetic fibers fixation of the reactive groups must be more on the surface. Reactive polycarboxylic acid compounds have been effective in fixing cationic compounds such as choline chloride. This reaction in combination with oxidized polyethylene and aminofunctional silicones has been effective in achieving desirable ionic properties on synthetic fibers.

The presence and the durability of the ionizeable finish may be determined by several methods. Where the ionizeabie finish uses a sulfur compound such as a sulfate, an elemental analysis of the amount of sulfur present may be used. A rapid method is to perform a dyeing with a cationic dye such as methylene blue. In this case the cationic dye is attracted to the anionic sulfate group. The presence and the intensity of the blue color will indicate the relative amount of the sulfate groups. This testing can best be conducted on white fabric. A second method is to measure the electrical resistivity of the fabric. Ionizeable finishes decrease the electrical resistivity and also decrease the time of decay of a given charge on the fabric. Various ionizeable finishes will affect this electrical resistivity differently.

The following examples are to further illustrate the invention but it is not to be considered as limited thereto.

### Example 1

### Finish for Noncellulosic Containing Synthetic Fabrics

| | % On Weight of Bath |
|---|---|
| Water | 68.4 |
| Triclosan (5-chloro-2-(2-4 | 2.0 |
| dichlorophenoxy phenol) | |
| Crosslink RB 105 (a reactive polycarboxylic | 8.0 |
| acid made by Biolab, Inc.) | |
| Crosslink WC 205 (a sodium hypophosphite | 4.0 |
| catalyst made by Biolab, Inc.) | |
| Choline chloride (70% active, | 3.6 |
| made by BCP Corp.) | |
| Caustic soda (50% sodium hydroxide) | 0.8 |
| Water | 10.0 |
| Ultrasoft NPE 40 (oxidized polyethylene | 1.5 |
| softener made by MFG Company) | |
| Sil Fin WHP (an aminofunctional silicone | 1.5 |
| made by Boehme Filatex) | |
| Wetting agent (generic) | 0.2 |

The Ultrasoft NPE 40, Sil Fin WHP, wetting agent, and the 10% water are mixed together and added slowly with stirring to the other ingredients added in the order indicated. The fabric is padded and then dried under heat setting conditions of 380° F. for 48 seconds.

### Examples 2-4

Three additional formulations are prepared. In the first, a water based suspension of diiodomethyl-p-tolylsulfone is substituted for the triclosan. In the second, a finely divided suspension of imidazole and pyrithione is substituted for the triclosan. In the third a water based solution based upon silver ion technology is substituted for the triclosan.

### Example 5

An ionization finishing composition or formulation for synthetic fibers includes 0.4% anionic surfactant, 0.2% nonionic surfactant, 4.0% polyester/polyethylene glycol blocked copolymer, 10.0% maleic acid/acrylic acid copolymer (adjusted to a pH of 2.8 with phosphoric acid), 3.0% triclosan and the balance water.

The same formulation may also be used on cellulose containing fabrics. Other softeners such as polyethylene and silicones may be added. The type and amount of the softness will depend upon the moisture management properties desired. The molecular weight of the maleic acid/acrylic acid copolymer should be at least 20,000 for optimum performance.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A composition for treating fabric, comprising in weight percent:
about 0.1 to about 10.0% cross linking agent;
about 0.1 to about 5.0% of a material selected from a group consisting of oxidized polyolefin, polyolefin and mixtures thereof;
about 0.1 to about 0.5% wetting agent;
about 1.0 to about 14.0% of a material selected from a group consisting of aminofunctional silicone, ionizing, agent and mixtures thereof;
about 0.0 to about 2.0% catalyst;
about 1.0 to about 3.0% antimicrobial/antibacterial/antifungal agent; and
any remainder as a carrier;
wherein the composition has a pH of between about 2.0 to about 4.

2. The composition of claim 1, wherein said cross linking agent is selected from a group consisting of a polycarboxylic acid, a low molecular weight polymaleic acid, a copolymer of maleic acid and other monomers, citric acid, butanetetracarboxylic acid, a polyfunctional blocked isocyanate, a polyfunctional epoxide and mixtures thereof and said polyolefin is selected from a group consisting of polyethylene, polypropylene and mixtures thereof.

3. The composition of claim 1, wherein said aminofunctional silicone is ionizeable and is selected from a group consisting of silicone polymers containing amine groups and mixtures thereof.

4. The composition of claim 1, wherein said catalyst is selected from a group consisting of sodium hypophosphite, sodium phosphate, sodium hydroxide, sodium carbonate and mixtures thereof.

5. The composition of claim 1, wherein said ionizing agent is selected from a group consisting of choline chloride, chitosan, glycidyl-trimethylammonium chloride, other reactive quaternary compounds and mixtures thereof.

6. The composition of claim 1, wherein said wetting agent is selected from a group consisting of nonionic and anionic surfactants and mixtures thereof.

7. The composition of claim 1, wherein said carrier is selected from a group consisting of water, air, alcohol, other water soluble compounds and mixtures thereof with or without water may be utilized.

8. The composition of claim 1, wherein said antimicrobial/antibacterial/antifungal agent is selected from a group of agents consisting of an aqueous dispersion based upon 5-chloro-2-(2,4 dichlorophenoxy)phenol, a water based suspension of diiodomethyl-p-tolyl sulfone, a finely divided powder of diiodomethyl-p-tolyl sulfone, a finely divided suspension of imidazole and pyrithione, a water based solution based upon silver ion technology and mixtures thereof.

9. A performance fabric, comprising:
a fabric substrate treated with a composition having in weight percent:
about 0.1 to about 10.0% cross linking agent;
about 0.1 to about 5.0% of a material selected from a group consisting of oxidized polyolefin, polyolefin and mixtures thereof;
about 0.1 to about 0.5% wetting agent;
about 1.0 to about 14.0% of a material selected from a group consisting of aminofunctional silicone, ionizing agent and mixtures thereof;
about 0.0 to about 2.0% catalyst;
about 1.0 to about 3.0% antimicrobial/antibacterial/anti fungal agent; and
any remainder as a carrier;
wherein said composition has a pH of between about 2.0 and about 4.

10. The performance fabric of claim 9, wherein said, fabric substrate is a noncellulosic synthetic material.

11. The performance fabric of claim 9, wherein said fabric substrate is selected from a group of noncellulosic synthetic materials including nylon, polyester, elastomers, acrylics, and any mixtures thereof.

12. The performance fabric of claim 11, wherein said fabric further includes natural fibers blended with said noncellulosic synthetic material.

13. The performance fabric of claim 9 wherein said antimicrobial/antibacterial/antifungal agent is selected from a group of agents consisting of triclosan, silver ion and mixtures thereof.

14. A method of preparing a performance fabric, comprising:
treating a fabric substrate with a composition having in weight percent:
about 0.1 to about 10.0% cross linking agent;
about 0.1 to about 5.0% of a material selected from a group consisting of oxidized polyolefin, polyolefin and mixtures thereof;
about 0.1 to about 0.5% wetting agent;
about 1.0 to about 14.0% of a material selected from a group consisting of aminofunctional silicone, ionizing agent and mixtures thereof;
about 0.0 to about 2.0% catalyst;
about 1.0 to about 3.0% agent; and
any remainder as a carrier;
wherein said composition has a pH of between about 2.0 and about 4.

15. The method of claim 14, wherein said treating step includes applying said composition to said fabric substrate, drying said composition and curing said composition on said fabric substrate.
